(19) United States
(12) Patent Application Publication
(10) Pub. No.: US 2015/0350858 A1
(43) Pub. Date: Dec. 3, 2015

(54) Systems and Methods for Monitoring Mobile Device Users

(71) Applicant: EmergenSee, LLC, Malvern, PA (US)

(72) Inventors: Philip A. Reitnour, Malvern, PA (US); Benjamin F. Reitnour, Malvern, PA (US); Nicholas R. Reitnour, Malvern, PA (US); John T. Reitnour, Malvern, PA (US); Sarah E. Reitnour, Malvern, PA (US)

(73) Assignee: EmergenSee, LLC, Malvern, PA (US)

(21) Appl. No.: 14/289,105

(22) Filed: May 28, 2014

(51) Int. Cl. H04W 4/22; H04W 64/00; G06F 3/0481; H04W 4/14; H04M 1/725

(52) U.S. Cl. CPC H04W 4/22; H04W 4/14; H04M 1/72519; G06F 3/04817; H04W 64/00

(57) ABSTRACT

A system and method for monitoring users of a plurality of mobile devices within a predetermined geographical area includes receiving a communication from at least one mobile device that indicates a geographic location of the at least one mobile device. Based on the communication received from the at least one mobile device, an icon indicating the geographic location of the at least one mobile device is graphically displayed on a map on the GUI. In addition to information regarding geographic location, visual data from the at least one mobile device may also be received and displayed on the GUI. The system and method may also include sending and displaying text messaging to the at least one mobile device.

### BACKGROUND

Emergency response systems typically operate on a reaction-based model, depending on unreliable eyewitness accounts and investigating emergency situations after they have already occurred. Such systems are unable to determine what has happened in the critical moments of these situations, right after they begin.

### SUMMARY

The systems and methods described herein function to monitor mobile device users when the user indicates that an incident has begun or may occur in the near future. The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

In some embodiments, a system and method for monitoring users of a plurality of mobile devices within a predetermined geographical area includes receiving a communication from at least one mobile device that indicates a geographic location of the at least one mobile device. Based on the communication received from the at least one mobile device, an icon indicating the geographic location of the at least one mobile device is graphically displayed on a map on a graphical user interface (GUI). In addition to information regarding geographic location, visual data from the at least one mobile device may also be received and displayed on the GUI. The system and method may also include sending text messaging to the at least one mobile device.

In some embodiments, a system and method for graphically displaying information received from a mobile device includes receiving a first communication from the mobile device that indicates a geographic location of the mobile device. Based on the communication received from the mobile device, a first icon corresponding to the first geographic location is graphically displayed on a map. After receiving the first communication, a second communication is received from the mobile device indicating a second geographic location of the mobile device. Based on the first and second locations, a direction of movement of the mobile device is determined. A second icon corresponding to the second location of the mobile device is displayed on the map, and that second icon includes an arrow indicating the determined direction of movement of the mobile device.

In some embodiments, a system and method for facilitating communication with a user of a mobile device includes receiving a first communication from the mobile device that indicates a geographic location of the mobile device. Based on the communication received from the mobile device, a graphical user interface displays a list of pre-composed messages. An operator selects a pre-composed message from the list of pre-composed messages and the selected pre-composed message is sent to the mobile device.

Further, in some embodiments, the system and method includes receiving a communication from the mobile device that indicates a geographic location of the mobile device, and determining from the geographic location a street address corresponding to the geographic location. A message requesting that the user of the mobile device confirm whether the user is present at the determined street address is then sent automatically to the mobile device, and without user intervention.

In other embodiments, a system and method for monitoring a user of a mobile device during an activity includes receiving a first communication from the mobile device that indicates a geographic location of the mobile device and information regarding a predetermined period of time associated with the activity. Based on the communication received from the mobile device, a timer, located remote from the mobile device, is set for the predetermined period of time. If further communication from the mobile devices does not occur before expiration of the timer, a determination is made as to whether an emergency situation exists.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

The following description is better understood when read in conjunction with the appended drawings. For purposes of illustrating the systems and methods for monitoring mobile device users disclosed herein, there is shown in the drawings exemplary embodiments thereof. However, the claimed systems and methods are not limited to the specific embodiments disclosed. In the drawings:

FIG. 1 is a schematic of an exemplary embodiment of a system and method for monitoring mobile device users;

FIG. 2 is a schematic of a portion of the exemplary embodiment of a system and method for monitoring mobile device users shown in FIG. 1;

FIG. 3 is a schematic of a portion of the exemplary embodiment of a system and method for monitoring mobile device users shown in FIGS. 1 and 2;

FIG. 4 is a block diagram of one embodiment of a computer system in which aspects of the disclosed systems and methods may be embodied;

FIG. 5 is a flowchart of a system and method for monitoring mobile device users that includes various methods of responding to an emergency situation;

FIG. 6 is a flowchart of a system and method for monitoring mobile device users that includes tracking locations and direction of movement of a mobile device user;

FIG. 7 is a flowchart of a system and method for monitoring mobile device users that includes messaging a mobile device user after the mobile device user indicates that an emergency situation exists;

FIG. 8 is a flowchart of a system and method for monitoring mobile device users that includes monitoring a mobile device user for a predetermined length of time and determining if an emergency situation exists;

FIG. 9 is a system and method for monitoring mobile device users that includes capturing and sending GPS coordinates and digital images to at least one recipient;

FIG. 10 is an exemplary embodiment of a user interface for a system and method for monitoring mobile device users;

FIG. 11 is an exemplary embodiment of a user interface for a system and method for monitoring mobile device users showing a geographical area being monitored;

FIG. 12a is an exemplary embodiment of a user interface for a system and method for monitoring mobile device users showing locations of user-reported emergency situations;

FIG. 12b is an exemplary embodiment of a user interface for a system and method for monitoring mobile device users showing locations of user-reported emergency situations;

FIG. 13 is an exemplary embodiment of a user interface for a system and method for monitoring mobile device users showing numbers of reported emergency situations in various geographical areas;

FIG. 14 is an exemplary embodiment of a user interface for a system and method for monitoring mobile device users showing locations of user-reported emergency situations, visual data from a mobile device of a user who reported emergency situation, and previous locations and directions of movement of the mobile device of the user;

FIG. 15 is an exemplary embodiment of a user interface for a system and method for monitoring mobile device users showing visual data from a mobile device of a user who reported an emergency situation;

FIG. 16 is an exemplary embodiment of a user interface for a system and method for monitoring mobile device users showing biographical information of a mobile device user;

FIG. 17 is an exemplary embodiment of a user interface for a system and method for monitoring mobile device users showing a broadcast message window;

FIG. 18 is an exemplary embodiment of a user interface for a system and method for monitoring mobile device users showing visual data received from a mobile device and an indication that an incident has been closed;

FIG. 19 is an exemplary embodiment of a user interface for a system and method for monitoring mobile device users showing closed incidents;

FIG. 20 is an exemplary embodiment of a user interface for a system and method for monitoring mobile device users showing current and previous locations and directions of movement of the mobile device of the user;

FIG. 21 is yet another exemplary embodiment of a user interface for a system and method for monitoring mobile device users showing current and previous locations and directions of movement of the mobile device of the user;

FIG. 22a is an exemplary embodiment of a user interface for a system and method for monitoring mobile device users showing a message from a system operator;

FIG. 22b is an exemplary embodiment of a user interface for a system and method for monitoring mobile device users showing a message exchange between a mobile device user and a system operator;

FIG. 23a is an exemplary embodiment of a user interface for a system and method for monitoring mobile device users showing a message exchange between a mobile device user and a system operator;

FIG. 23b is an exemplary embodiment of a user interface for a system and method for monitoring mobile device users showing suggested messages to send a mobile device user;

FIG. 24a is an exemplary embodiment of a user interface for a system and method for monitoring mobile device users showing a first screen of a virtual escort mode; and

FIG. 24b is an exemplary embodiment of a user interface for a system and method for monitoring mobile device users showing a second screen of a virtual escort mode.

### DETAILED DESCRIPTION OF ILLUSTRATIVE EMBODIMENTS

The various aspects of the subject matter described herein are now described with reference to the accompanying drawings, wherein like numerals refer to like or corresponding elements throughout. It should be understood, however, that the drawings and detailed description relating thereto are not intended to limit the claimed subject matter to the particular form disclosed. Rather, the intention is to cover modifications, equivalents, and alternatives falling within the spirit and scope of the claimed subject matter.

Components described below relate to a computer-related entity, either hardware, a combination of hardware and software, software, or software in execution. For example, components may be, but are not limited to being, a process running on a processor, a processor, an object, an executable instruction, a thread of execution, a program, and/or a computer. By way of illustration, both an application running on a computer and the computer can be a component. One or more components may reside within a process and/or thread of execution and a component may be localized on one computer and/or distributed between two or more computers.

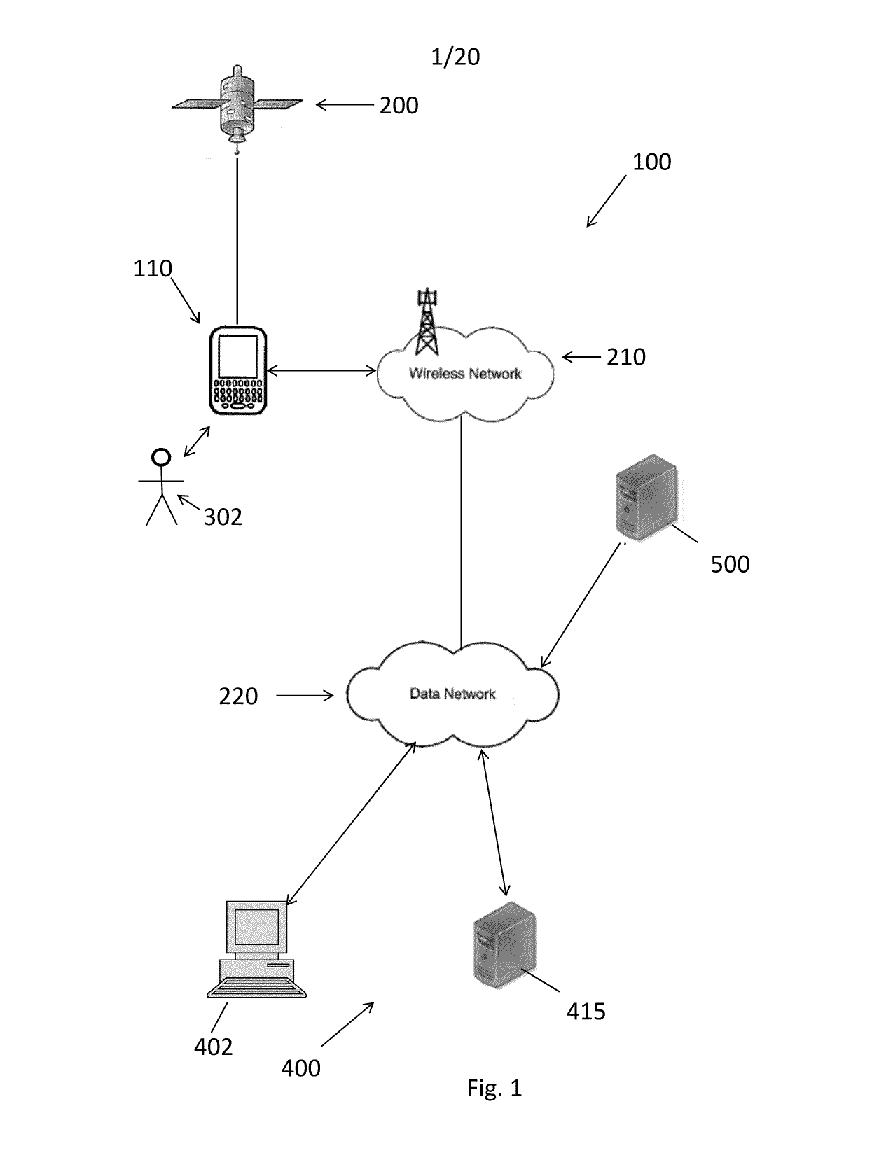

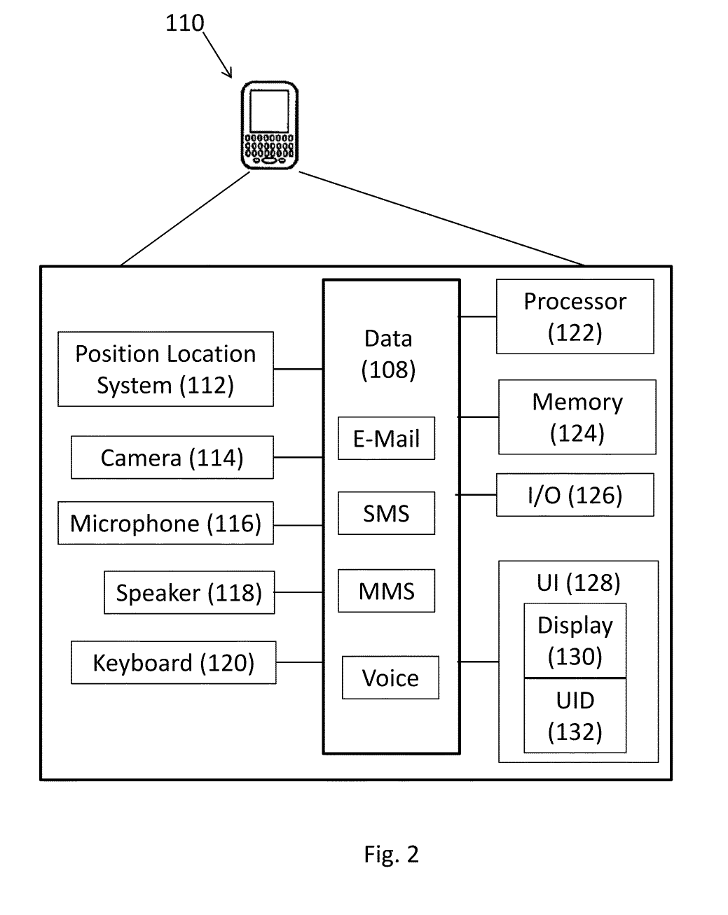

With reference to FIGS. 1-3, the following description relates to a system 100 that includes one or more mobile devices 110 and a monitoring subsystem 400. Each mobile device 110 may comprise any suitable device, examples of which include a portable computing device, such as a tablet or laptop, a personal digital assistant (“PDA”), a portable phone (e.g., a cell phone or the like, a smart phone, a video phone), a portable email device, or a combination thereof. Device 110 may be a wireless device that includes a position location system 112, such as a GPS receiver that uses the wireless device's antenna to receive signals from a multiplicity of GPS satellites and process those signals to determine its position therefrom, a camera 114, such as a digital video and/or still camera, a microphone 116, a speaker 118, and a keyboard 120 (either physical or electronically displayed on a touch screen).

The position location system 112 works in conjunction with GPS satellites 200 that comprise any group of satellites that transmit GPS downlinks used for positioning by a GPS receiver of the position location system 112. Each satellite has a computer, a clock, and a radio on board, and continually broadcasts its changing position and time. The GPS receiver is housed within or is coupled to the wireless mobile device and triangulates its own position by processing the signals from downlinks from three or more satellites, resulting in a longitude and latitude position. In some GPS receivers, timing information that is derived from the processing of the received GPS signals from downlinks is provided over a cellular (or other wireless link) to a remote entity which in turn computes the position of the GPS receiver. Such systems are sometimes called Assisted GPS receivers (AGPS). The position location system described herein could include either conventional and/or AGPS receivers, as well as other position location devices and methods.

Device 110 includes a wireless telecommunication system that is designed to transmit and receive data 108 between the device 110 and wireless network 210, such as cellular base stations, WiFi hubs, etc. Any conventional telecommunication system can be used in the invention for communicating data 108.

Device 110 further comprises a processor 122, a memory 124, an input/output interface 126, and a user interface 128 that includes a display 130, which may display the user interface graphically, and a user input device 132. The processor 122, memory 124, the input/output interface 126, and the user interface 128 cooperate to allow communications therebetween. In various embodiments, the input/output interface 126 comprises a receiver of the computing device, a transmitter of the computing device, or a combination thereof. The input/output interface 126 is capable of sending and receiving information over a network such as, for example, the Internet.

The user interface 128 of device 110 can provide the ability to control the device 110, via, for example, buttons, soft keys, voice actuated controls, a touch screen, movement of the device 110, visual cues (e.g., moving a hand in front of a camera on the device 110), or the like. The device user interface 128 can provide visual information (e.g., via display 130), audio information (e.g., via speaker 118), mechanically (e.g., via a vibrating mechanism), or a combination thereof. The device user interface 128 can comprise means for inputting biometric information, such as, for example, fingerprint information, retinal information, voice information, and/or facial characteristic information. The device 110, such as a smart phone or tablet, may also communicate with an application store via a network such as, for example, the Internet. The application store may be, for example, a company specific store or an open device specific store.

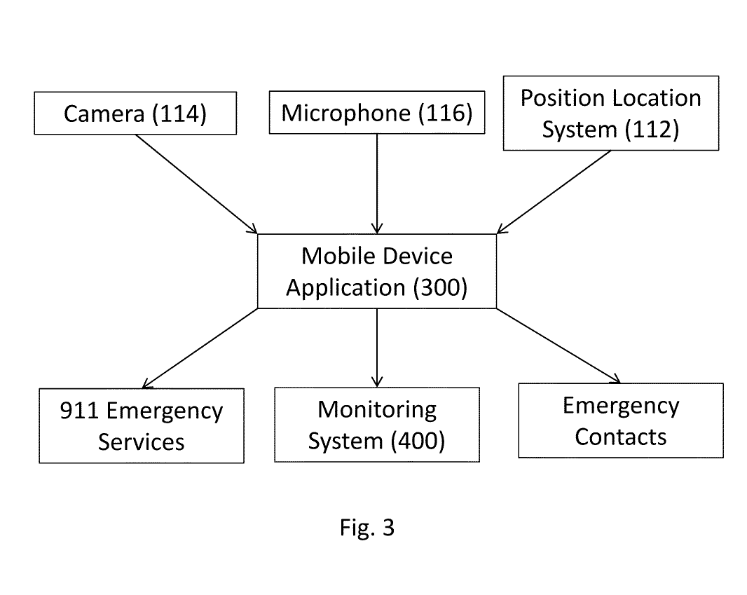

With reference to FIG. 3, the system 100 includes a mobile device application 300, which is installed on the mobile device 110. The mobile device application 300 may comprise computer-executable instructions, or program code, stored on a non-transitory computer readable storage medium within the mobile device. The computer-executable instructions of the mobile device application 300, when executed by the processor 122 of the mobile device, cause the mobile device 110 to perform various emergency reporting and monitoring functions as described more fully below. The application 300 may be loaded onto the device 110 either through a wired or wireless connection, such as via a download from a remote storage location, like a server hosting a site with multiple applications (e.g., the Apple App Store), that are downloaded by users 302. The application 300 may be available to users 302 for free, or for a purchase fee. Alternatively, users 302 may pay for use of the application 300 on a recurring basis. For example, a user 302 may pay to use the application 300 for a period of time, such as a month. Alternatively, a user 302 may pay per use to use the application 300.

Application 300 uses device 110 to communicate with the monitoring subsystem 400 via the wireless network 210 and the data network 220. The wireless network 210 may be any wireless network, such as a wireless network operated by a mobile network operator (e.g., AT&T, Sprint, T-Mobile, etc.). The data network 220 may comprise any public or private data network, including the Internet or an intranet. The monitoring subsystem 400 may be in communication with third-party servers/databases, such as third-party database 500, via the data network 220.

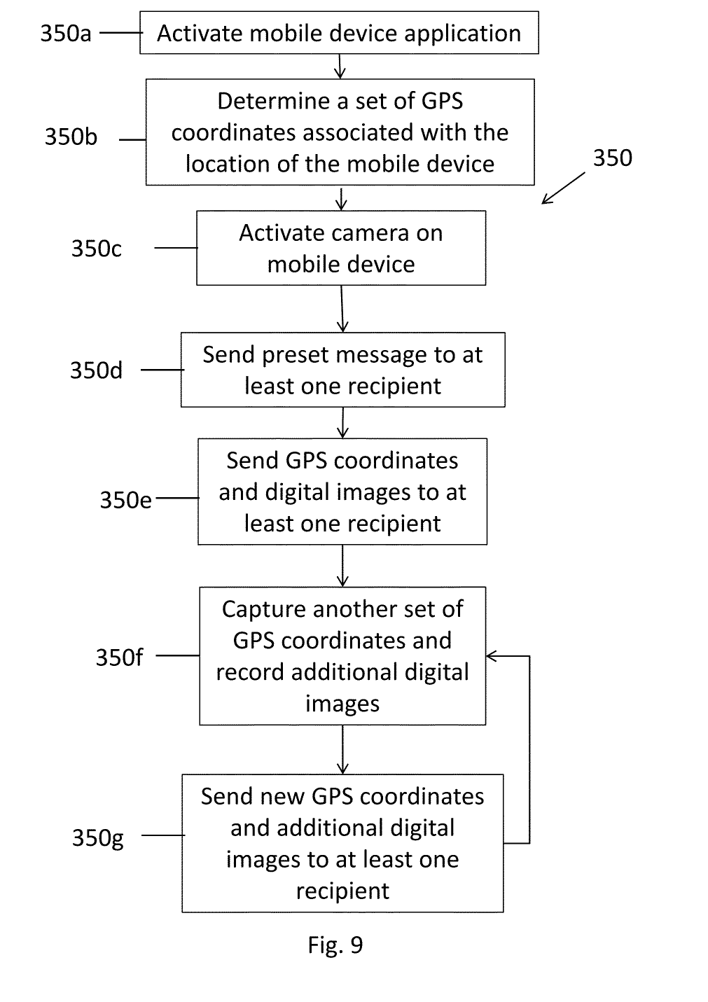

FIG. 9 is a flow diagram illustrating the operation of the mobile application in accordance with one embodiment thereof. At step 350a, a user activates the application on the user's mobile device. Upon activation, the mobile application performs the following steps automatically and without further user input. First, at step 350b, the mobile device 110 resolves a set of GPS coordinates associated with the location of the mobile device. At step 350c, the mobile application activates a camera on the mobile device 110 to record digital images and/or audio over a period of time. Digital images may include both video and still images. At step 350d, the mobile application sends a preset message from the mobile device 110 to at least one recipient. The preset message is set before the user activates the mobile application. At step 350e, the mobile application sends the set of GPS coordinates and the digital images and/or audio from the mobile device 110 to at least one remote recipient, such as monitoring subsystem 400. At step 350f, after a predetermined period of time, the mobile application captures another set of GPS coordinates associated with the current location of the mobile device 110 and records additional digital images and/or audio over a period of time. At step 350g, the mobile application sends the new GPS coordinates and the additional digital images and/or audio from the mobile device 110 to at least one remote recipient, such as monitoring subsystem 400. Steps 350f and 350g are then repeated such that updated GPS coordinates and additional digital images and/or audio are sent to at least one remote recipient, such as monitoring subsystem.

In one embodiment, the monitoring subsystem 400 comprises a server application (referred to herein also as a “monitoring application”) running on one or more computer servers 415 (shown in FIG. 1), also referred to herein as a “monitoring server.” The server application may be implemented in accordance with any of a variety of different server architectures, such as via one or a combination of network-based hosted services, cloud services, Software as a Service (SaaS), Communications as a Service (CaaS), virtual services, on-demand services, public switched telephone network (PSTN) services or the like.

In one embodiment, organizations or entities desiring to monitor mobile devices 110 in a given geographic area, such as a university campus security department or other security organization, can establish an account with the monitoring subsystem 400 which provides that organization or entity with web browser-based access to the services and functions provided by the monitoring server application of the monitoring subsystem 400. Once an account is established, monitoring personnel of an organization or entity can direct a web browser running on a computing device 402 of the organization to the URL of the monitoring server 415 or its monitoring application. The computing device 402 may be any suitable computing device, such as a desktop computer, laptop computer, tablet, mobile device, or the like, which includes a web browser and is capable of communicating via the data network 220.

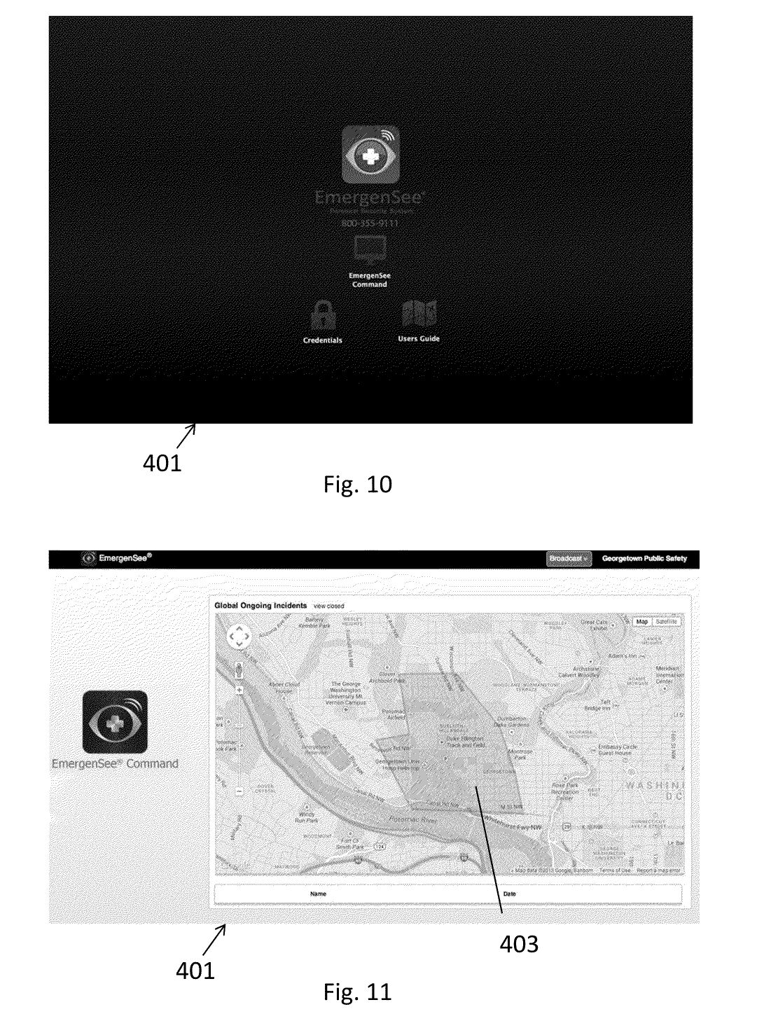

FIG. 10 is an example log-in screen that may be presented via the web browser of computing device 402 to the monitoring personnel after connecting to the monitoring server 415. In this example, monitoring personnel may click the icon “EmergenSee Command” to log-in to the monitoring application. Once logged-in to the monitoring application, the web browser of the computing device 402 may present to the monitoring personnel another screen of the graphical user interface 401, such as the example screen shown in FIG. 11, which displays to the monitoring personnel a map with a highlighted area 403 delineating the geographic area from which the organization or entity may receive emergency notifications from users of mobile devices in that area. For example, monitoring subsystem 400 may be configured to send broadcast alerts only to mobile devices 110 located in the particular predetermined geographical area 403. Operators of monitoring subsystem 400 can adjust this predetermined geographical area using user interface 401. Further details of the functions and operations of the monitoring application of the monitoring subsystem 400 are presented below.

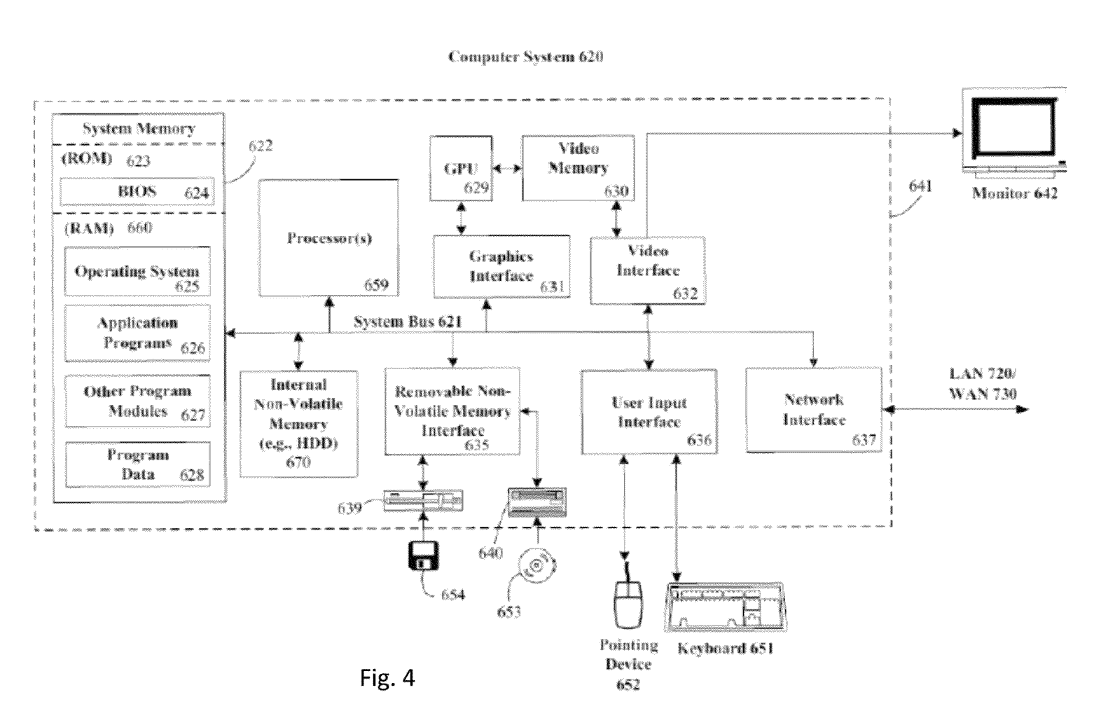

Referring now to FIG. 4, a block diagram of an example computer system 620 on which the embodiments described herein and/or various components thereof may be implemented is shown. For example, each of the server(s) 415 that host the monitoring application of the monitoring subsystem, the computing device 402 of the organization or entity having an account on the monitoring subsystem 400, and even one of the mobile devices 110, may be implemented by the example computer system 620 of FIG. 4. It is understood, however, that the computer system 620 is just one example of a suitable computing environment and is not intended to suggest any limitation as to the scope of use or functionality of the presently disclosed subject matter. Neither should the computer system 620 be interpreted as having any dependency or requirement relating to any one or combination of components illustrated in FIG. 4. In some embodiments, the various depicted computing elements may include modules or components configured to instantiate specific aspects of the present disclosure.

For example, the components used in this description may include specialized hardware components configured to perform function(s) by firmware or switches. In other example embodiments, components may include a general purpose processor, memory, etc., configured by software instructions that embody logic operable to perform function(s). In example embodiments where modules or components include a combination of hardware and software, an implementer may write source code embodying logic and the source code may be compiled into machine readable code that can be processed by the general purpose processor. Since the state of the art has evolved to a point where there is little difference between hardware, software, or a combination of hardware/software, the selection of hardware versus software to effectuate specific functions is a design choice left to an implementer. More specifically, a software process may be transformed into an equivalent hardware structure, and a hardware structure may itself be transformed into an equivalent software process. Thus, the selection of a hardware implementation versus a software implementation is one of design choice and left to the implementer.

In FIG. 4, the computer system 620 comprises a computer 641, which may include a variety of computer readable media. Computer readable media may be available media that may be accessed by computer 641 and may include volatile and/or nonvolatile media, removable and/or non-removable media. The system memory 622 may include computer storage media in the form of volatile and/or nonvolatile memory such as read only memory (ROM) 623 and random access memory (RAM) 660. A basic input/output system 624 (BIOS), containing the basic routines that help to transfer information between elements within computer 641, such as during start-up, may be stored in ROM 623. RAM 660 may contain data and/or program modules that are immediately accessible to and/or presently being operated on by processing unit 659. By way of example, and not limitation, FIG. 4 illustrates operating system 625, application programs 626, other program modules 627, and program data 628. As a further example, video content (e.g. video frames) and/or metadata (e.g. closed caption data), in one embodiment, may be stored in the system memory 622, as well as in any of a variety of non-volatile memory media discussed herein.

The computer 641 may also include other removable/non-removable, volatile/nonvolatile computer storage media. By way of example, the computer 641 may include a hard disk drive 670 that reads from or writes to non-removable, nonvolatile magnetic media, a magnetic disk drive 639 that reads from or writes to a removable, nonvolatile magnetic disk 654, and an optical disk drive 640 that reads from or writes to a removable, nonvolatile optical disk 653 such as a CD ROM or other optical media. Other removable/non-removable, volatile/nonvolatile computer storage media that can be used in the exemplary operating environment include, but are not limited to, magnetic tape cassettes, solid-state drives, flash memory cards, digital versatile disks, digital video tape, solid state RAM, solid state ROM, and the like. Magnetic disk drive 639 and optical disk drive 640 may be connected to the system bus 621 by a removable memory interface, such as interface 635. The drives and their associated computer storage media discussed herein, and illustrated in FIG. 4, may provide storage of computer readable instructions, data structures, program modules and other data for the computer 641. As used herein, the terms “computer-readable medium” and “computer-readable storage medium” refer to physical, non-transitory storage media and do not encompass transitory media, such as signals.

A user may enter commands and information into the computer 641 through input devices such as a keyboard 651 and/or pointing device 652, commonly referred to as a mouse, trackball, or touch pad. Other input devices (not shown) may include a microphone, joystick, game pad, satellite dish, scanner, or the like. These and other input devices may be connected to the processing unit 659 through a user input interface 636 that is coupled to the system bus, but may be connected by other interface and/or bus structures, such as a parallel port, game port, or a universal serial bus (USB) for example. The computer may connect to a local area network or wide area network, such as LAN 720 and/or WAN 730, through a network interface or adapter 637. For example, the computer 641 may connect to the wireless network 210 and/or the data network 220 of FIG. 1. A monitor 642 connects to the computer system 620 and may be used to display the various screens of graphical user interface 401, such as the graphical user interface screens shown in FIGS. 10-23b.

As is apparent from the embodiments described herein, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., computer executable instructions). This program code may be stored on a computer-readable storage medium, such as the various computer-readable storage media described above, wherein, when the program code is loaded into and executed by a machine, such as a computer or server, the machine becomes an apparatus for practicing the invention. The program code may be implemented in a high level procedural or object oriented programming language. Alternatively, the program code may be implemented in an assembly or machine language. In any case, the language may be a compiled or interpreted language. When implemented on a general-purpose processor, the program code may combine with the processor to provide a unique apparatus that operates analogously to specific logic circuits.

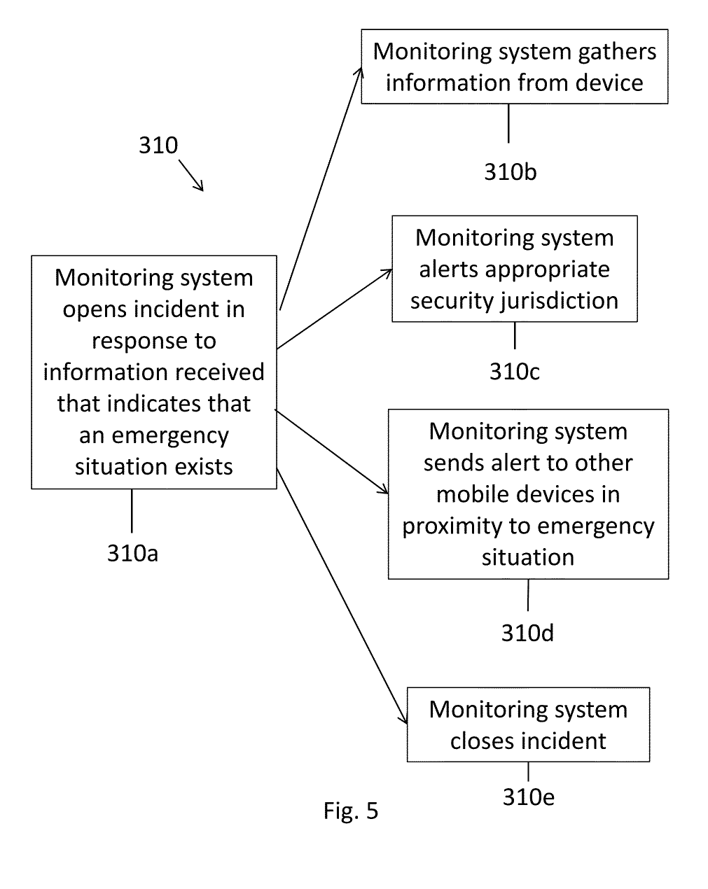

With reference now to FIGS. 5-23b, various modes of operation of the mobile device application 300 and the monitoring subsystem 400 are described, including an incident response mode, a tracking mode, a quick response mode, and escort mode.

### Incident Response Mode

FIG. 5 illustrates one embodiment of steps performed by the monitoring subsystem 400 in an incident response mode of operation. With reference to FIG. 5, the monitoring subsystem 400 may receive information from, for example, the mobile device application 300 running on device 110, indicating that an emergency situation exists. At step 310a, the monitoring subsystem 400 opens an incident.

Monitoring subsystem 400 may open an incident in response to several different types of information. For example, a user 302 may initiate incident response mode 310 via the application 300 on the user's mobile device 110 by simply opening the application 300. Alternatively, the user 302 may need to confirm that an emergency situation exists after opening the application for incident response mode 310 to be initiated. Incident response mode 310 may also be initiated remotely, for example by the monitoring subsystem 400 and/or a local law enforcement agency. For example, monitoring subsystem 400 may be alerted by a third party eyewitness that a user 302 is experiencing or has experienced an emergency situation, such as a mugging. An incident may also be opened as described below in relation to the escort mode 340 when monitoring subsystem 400 determines that an emergency situation exists because the monitoring system has not received expected information from the device 110.

When the incident response mode 310 is initiated via device 110, the device sends an incident creation request to the monitoring server 415. Monitoring server 415 then creates an object in memory with data associated with the incident. Monitoring server 415 then checks if the most recent reported location of the device 110 is within at least one predetermined geographical area 403. If the device is within at least one predetermined geographical area 403, the monitoring server 415 flags the object as being accessible to those organizations associated with the at least one predetermined geographical area 403.

When the incident response mode 310 is initiated via escort mode 340, the device sends an incident creation request to the monitoring server 415. Monitoring server 415 then creates an object in memory with data associated with the incident. Monitoring server 415 checks to see if the incident was created via escort mode 340. If so, monitoring server 415 retrieves previous location data points from the device 110 and calculates direction and velocity for data points after the first data point.

Once the object in memory is created, monitoring server 415 sends a hyperlink to the user's contacts via email and/or SMS text message. The hyperlink provides access to a website that displays recorded and real-time data from the incident. The message to the user's contact may also include data as to when the incident started and reported locations of the device.

Incident response mode 310 is configured to respond to an emergency situation in a multitude of ways. One, some, or all of these ways may be employed automatically and/or at the direction of an operator of the monitoring subsystem 400.

When incident response mode is initiated by opening an incident at step 310a, the application 300 on the device 110 may begin sending periodic communications to the monitoring subsystem 400, including information concerning the location of the mobile device 110 (e.g., GPS coordinates determined by the position location system 112), video or images captured by the camera 114 of the mobile device, and/or audio captured by the microphone 116 of the device.

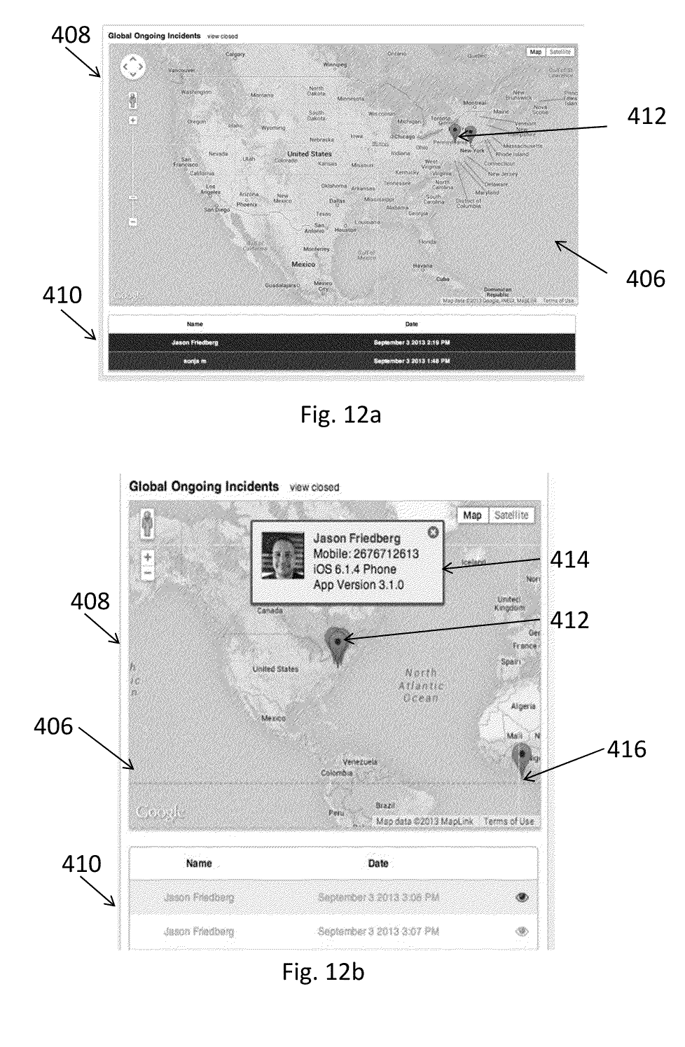

FIGS. 12a and 12b show views, or screens, of the graphical user interface 401 presented by the monitoring subsystem 400 to, for example, monitoring personnel of an organization operating the web browser of a computing device 402. In these views, different sized maps 406 are presented in a first window 408 of the interface 401. When a communication is received from the mobile device application 300 running on a user's mobile device 110, resulting in the monitoring subsystem 400 opening an incident for that communication, the incident is listed in a second window 410 of the graphical user interface 401, along with any other incidents that have been opened. In addition, an icon, such as pinpoint 412, is displayed on the map showing the location of the reported emergency situation, as determined from position information (e.g., GPS coordinates) included in the communication from the mobile device.

As further illustrated in FIG. 12b, when monitoring personnel select one of the incidents that has been opened, for example by single-clicking on the pinpoint 412 for that incident or single-clicking on the incident in the list shown in window 410, a pop-up window 414 may be displayed showing additional information about the user and/or the user's device. That information may be information that was included in the communication received from the mobile device 110, or it may be information stored by the monitoring subsystem 400 in a user profile created for the user of the mobile device upon the user registering with the monitoring subsystem 400. FIG. 12b also shows a default location 416. If position information is not resolvable, pinpoint 412 may appear at the default location 416. Default location 416 may be a location on the map 406 that is readily identifiable as being an erroneous location, such as an unpopulated geography.

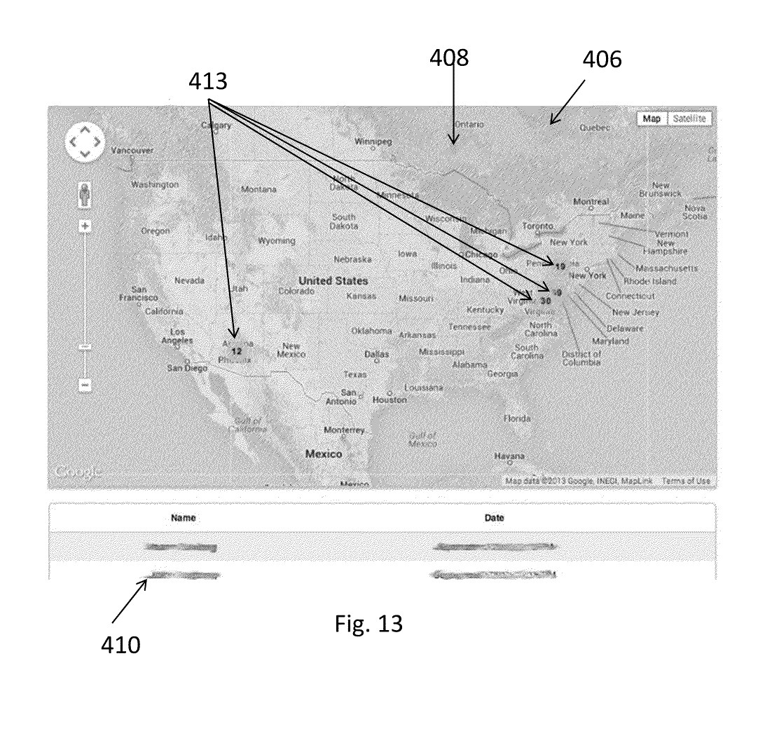

FIG. 13 illustrates another feature of the user interface 401 of monitoring subsystem 400. Specifically, when the number of incidents opened in a given geographic area becomes too great to clearly display the individual pinpoint icons for each incident, the incidents may be aggregated into a single, larger icon that displays a count of the number of incidents currently opened in that area. Four such larger icons are shown in this example at 413.

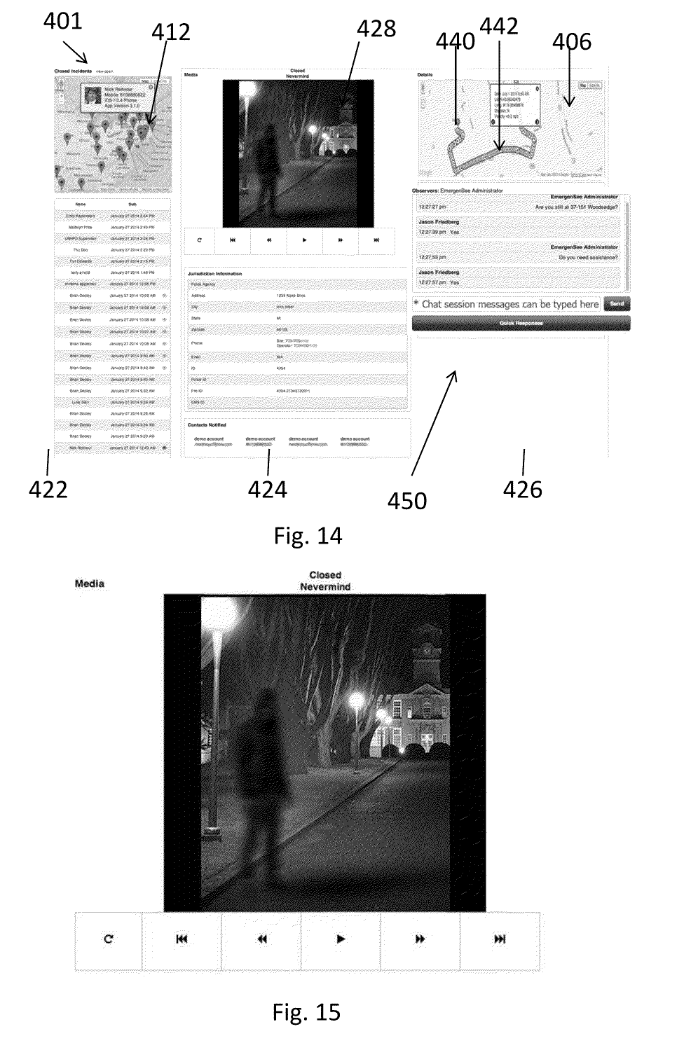

When monitoring personnel select an incident from the user interface 401, such as any of the views shown in FIGS. 12a-13, for example by double-clicking on the pinpoint 412 or double-clicking on the incident's listing in window 410, an incident-specific graphical user interface 401 is displayed. FIG. 14 shows one embodiment of an incident-specific view of the interface 401 that may be displayed to the monitoring personnel. As shown, this view of the interface 401 comprises three panels 422, 424, and 426. The first panel 422 is a reduced view of the larger view shown in FIG. 12a, providing essentially the same information as that larger view. The monitoring personnel can continue to interact with the pinpoints 412 and incident listing shown in panel 422, in the same manner as can be done using the views of interface 401 shown in FIGS. 12a-13. The second panel 424 provides a media viewer that displays any video or still images included in the communication(s) received from the mobile device 110 for that incident. The third panel 426 displays a detailed map 406 and pinpoint 412 of the location included in the communication from the mobile device 110. The third panel 426 also presents a text messaging interface 450 that the monitoring personnel can use to communicate with the user of the mobile device 110 via text messaging, as described in greater detail below in relation to quick response mode 330.

Referring back to FIG. 5, in incident response mode 310, the monitoring subsystem 400 receives data, such as position information and audio and video information, from device 110 at step 310b. When an operator of the monitoring subsystem 400 selects the incident, information received from the device 110 is shown. For example, with reference to FIGS. 14 and 15, a live video stream 428 from a camera 114 on the device may be displayed. The interface 401 may provide for replay, rewind, pause, and fast forward capabilities.

The monitoring application executing on the server 415 may also be configured to identify appropriate security jurisdiction(s) who may have responsibility for addressing emergency situations in the location of the mobile device identified from the GPS coordinates received from the device. At step 310c, the monitoring application will alert the appropriate security jurisdiction(s) of the emergency situation. For example, if a user 302 reports that he has just been mugged, the monitoring application will resolve the location, such as a street address, of the user 302 based on GPS coordinates received from the device 110. The monitoring application will then determine, based on the location, the security jurisdiction for that location. The security jurisdiction may be a local police department, campus police, or both. Monitoring subsystem 400 may rely on a third-party database 500 to provide information indicating the security jurisdiction(s) responsible for a given location. Known databases to which the monitoring subsystem 400 may connect to obtain security jurisdiction information include, for example, Pitney Bowes.

Additionally, depending on how application 300 is structured, and/or user preferences, the user interface 401 may indicate whether a user's emergency contacts have been notified. A user's emergency contacts may be at least partially predetermined by the user 302.

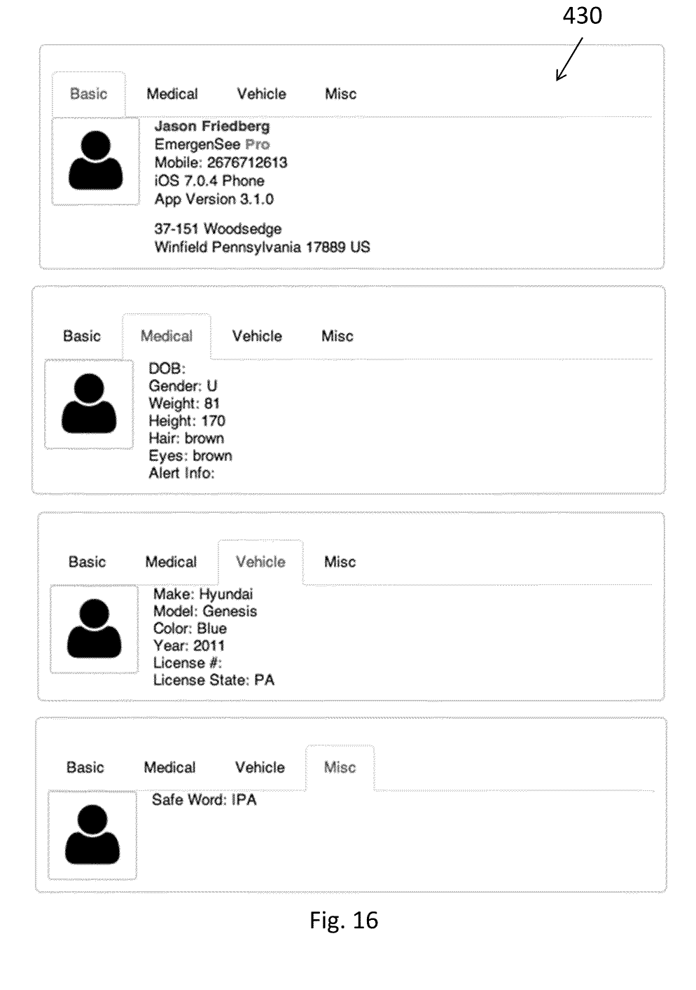

With reference to FIG. 16, monitoring subsystem 400 may have access to other types of biographical information 430 about user 302 that may also be displayed on the graphical user interface 401. Biographical information may be used by an operator of the monitoring subsystem 400 or another party with access to this information to understand the context of the emergency situation. For example, monitoring subsystem 400 may have information such as a home address, medical information, vehicle information, and a safe word. Monitoring subsystem 400 may also have access to a third-party database 500 that provides additional information, such as a daily schedule. For example, third-party database 500 may provide a class schedule for user 302. Additionally, monitoring subsystem 400 may receive schedule information from device 110, such as a personal calendar.

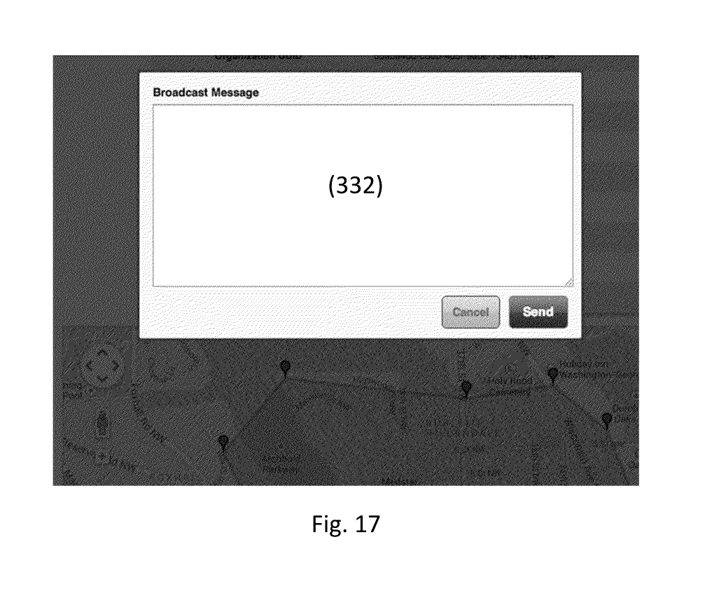

Optionally, at step 310d monitoring subsystem 400 may send a broadcast alert to other mobile devices 110 in proximity to the emergency situation (i.e., the location indicated in the communication received from the mobile device for which the incident was opened). With reference to FIG. 17, the monitoring application may present a pop-up window 332 to enable monitoring personnel to enter text of a broadcast message. After entering the text, the monitoring personnel may press “Send” to cause the message to be broadcast. For example, the monitoring personnel may use this feature to send out a broadcast message to alert other users 302 to avoid a certain location or to report suspicious activity. Step 310d may also be used in other contexts. For example, in an emergency weather situation, this feature may be used to alert students on a college campus that classes for a given day have been cancelled.

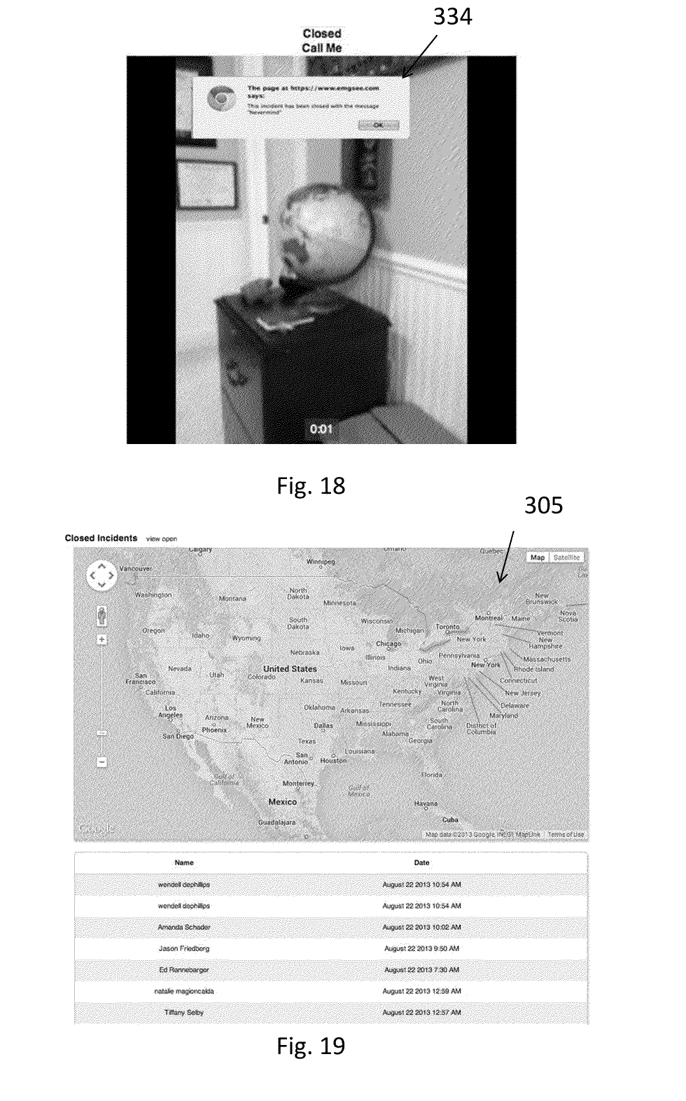

With reference to FIGS. 18 and 19, alternatively, or in addition to the steps described above, if monitoring subsystem 400 determines that an incident should be closed, the incident is closed at step 310e. For example, with reference to FIG. 18, if, after an incident has been opened, the user 302 indicates that he accidently reported that an emergency situation exists, monitoring subsystem 400 will close the incident and an icon 334 indicating the incident is closed will appear on the user interface 401. With reference to FIG. 19 closed incidents may be listed in part of the user interface 401.

In addition to the ways described above, an incident may also be closed if no data has been received from the device for at least 60 minutes. When an incident is closed, the incident's status is updated in the monitoring subsystem 400 and an email and/or SMS text message is sent to the user's contacts notifying them that the incident is being closed along with a reason that the incident is being closed.

### Tracking Mode

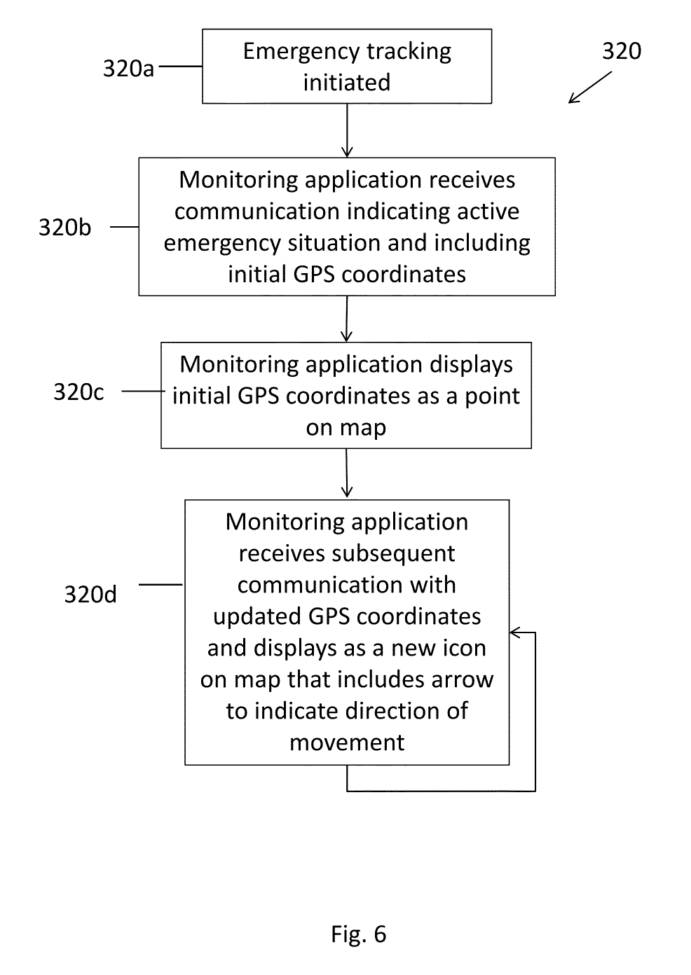

Incident response mode 310 includes a tracking mode 320 described separately in relation to FIG. 6. Tracking mode 320 of system 100 may be initiated at step 320a in several ways. For example, tracking mode 320 may be initiated along with incident response mode 310 when a user 302 activates the application 300 on the user's mobile device 110. Tracking mode 320 may be initiated by user 302 simply opening the application 300, or the user may need to confirm that an emergency situation exists after opening the application for tracking mode 320 to be initiated. Alternatively, tracking mode 320 may be initiated remotely, for example by the monitoring subsystem 400 and/or a local law enforcement agency. For example, monitoring subsystem 400 may be alerted that a user 302 has been abducted.

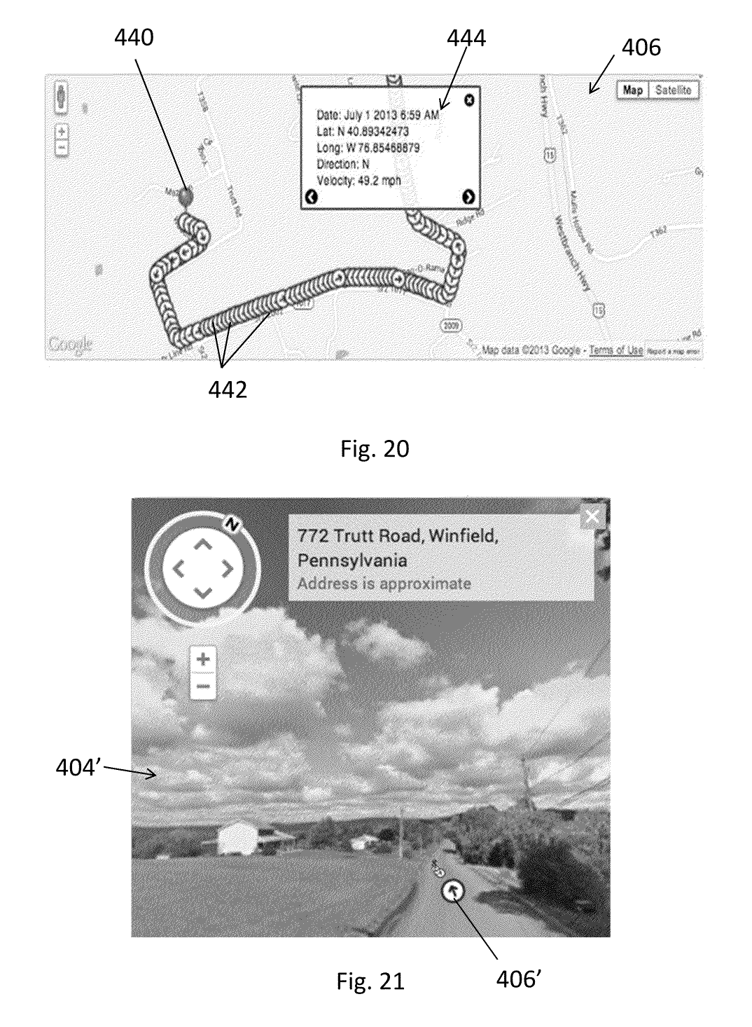

After tracking mode 320 is initiated at step 320a, device 110 sends a communication to monitoring subsystem 400 that includes an initial set of GPS coordinates for the device 110. At step 320b, the monitoring application of the monitoring subsystem 400 receives this communication. At step 320c, the monitoring application may then display these initial GPS coordinates as a first point 440 on the map 406 displayed in the third panel 426 of the view of the user interface 401 shown in FIG. 14. FIG. 20 show enlarged views of the map 406 of FIG. 14. The first point 440 may be displayed in multiple ways. For example, first point 440 may be displayed as a pinpoint or as a dot.

At described above, the mobile application executing on the device 110 automatically and periodically sends subsequent communications to the monitoring subsystem 400, each including updated GPS coordinates of the device. At step 320d, the monitoring subsystem 400 receives these communications and displays the subsequent GPS coordinates as subsequent points 442 on the map 406. In one embodiment, the subsequent points 442 are each displayed as a circular icon on the map that includes an arrow indicating a direction of movement of the device determined from the particular GPS coordinates represented by that icon. The direction of movement of the mobile device at each tracked point on the map may be determined by the device 110, the monitoring subsystem 400, or both. For example, the monitoring subsystem 400 may calculate direction of movement based on the most recent GPS data and the second most recent GPS data. The server 415 calculates direction using the changes in latitude and longitude to calculate the degree of an arc from the previous location to the current location. The server also calculates velocity using distance traveled per unit time. Step 320d continues to iteratively repeat as long as the mobile application on the device 110 remains active or the incident is otherwise closed.

In some embodiments, tracking mode 320 may further include displaying speed of movement on the user interface 401. Like determining direction of movement, speed of movement may be determined by the device 110, the monitoring subsystem 400, or both. For example, the monitoring subsystem 400 may calculate speed of movement based on the most recent GPS data and the second most recent GPS data. Speed of movement for each subsequent point 442 may be shown, for example, in a pop-up window 444 on map 406, as shown in FIG. 20.

With reference to FIG. 21, the first point (not shown) and subsequent points 408′ for a tracked mobile device may be shown on a three-dimensional map, such as a street view map 406′. The interface 401 shown in FIG. 14 may be modified such that third panel 426 shows the street view map 406′ instead of map 406.

### Quick Response Mode

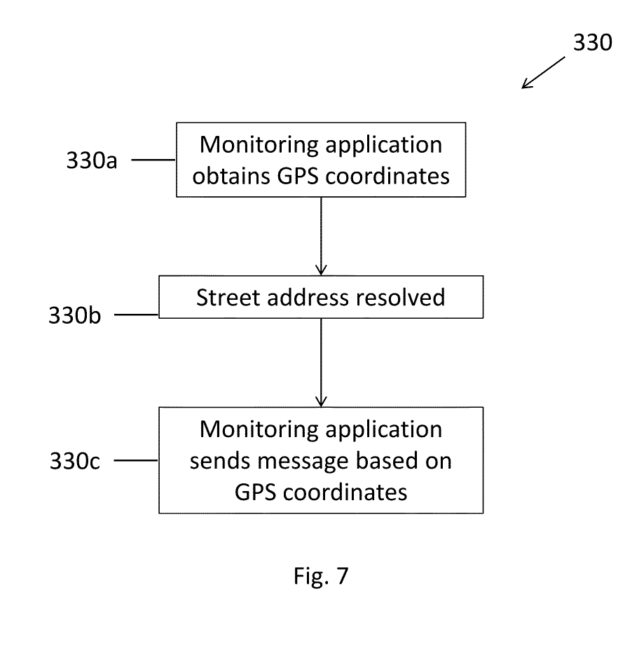

Incident response mode 310 may further include a quick response mode 330 described separately in relation to FIG. 7. In one embodiment, quick response mode is initiated automatically when an incident is opened upon receipt of the initial communication from an activated mobile application on the mobile device of a user.

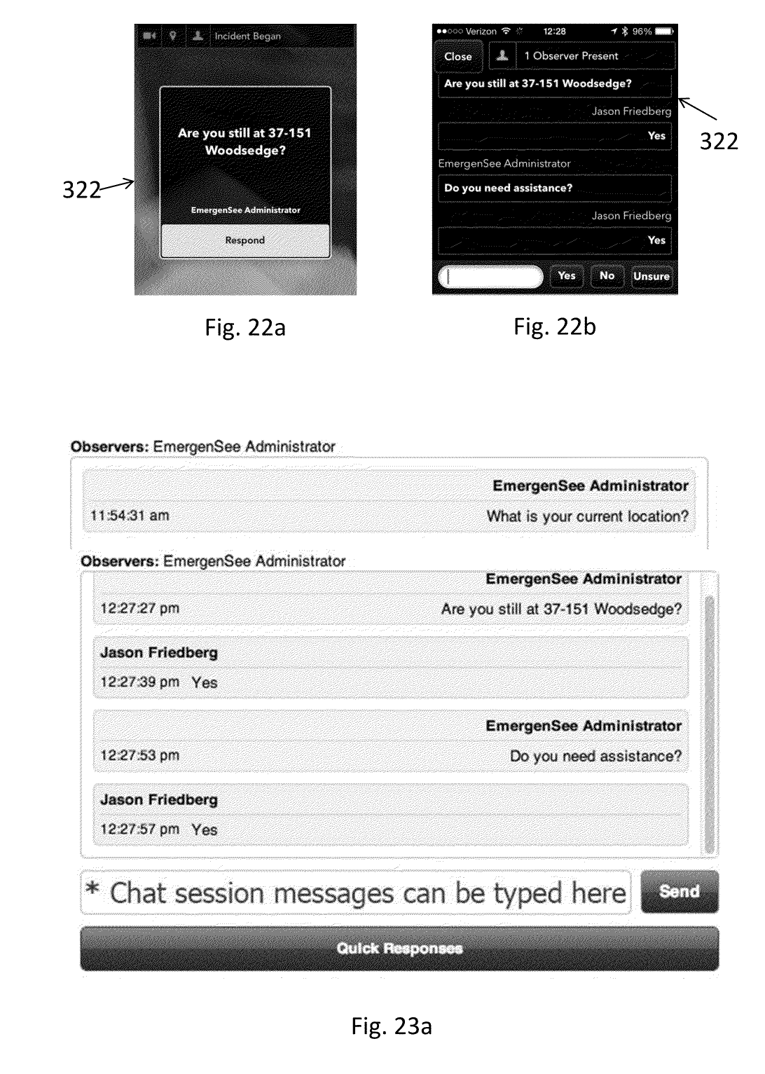

In quick response mode 330, at step 330a, the monitoring application obtains the GPS coordinates of the device from the initial communication received from the device's mobile application. At step 330b, the monitoring application attempts to resolve the street address indicated by the received GPS coordinates. Once a street address has been resolved, in step 330c, the monitoring application automatically sends a text message to the mobile device requesting the user of the device to confirm whether the user is actually located at that street address. This feature provides monitoring personnel with a quick, and automatic, way to confirm the user's location in an emergency situation. FIGS. 22a and 22b illustrates how the text of such a text message 322 may be displayed to the user by the mobile application running on the user's mobile device. As shown, the user may press “respond” to respond to the message.

In one embodiment, monitoring subsystem 400 may resolve a street address based on the GPS coordinates obtained in step 330a by connecting to a service such as Google Maps that determines a street address based on GPS coordinates. If a street address cannot be resolved, message 322 may ask for the address at which the user is located.

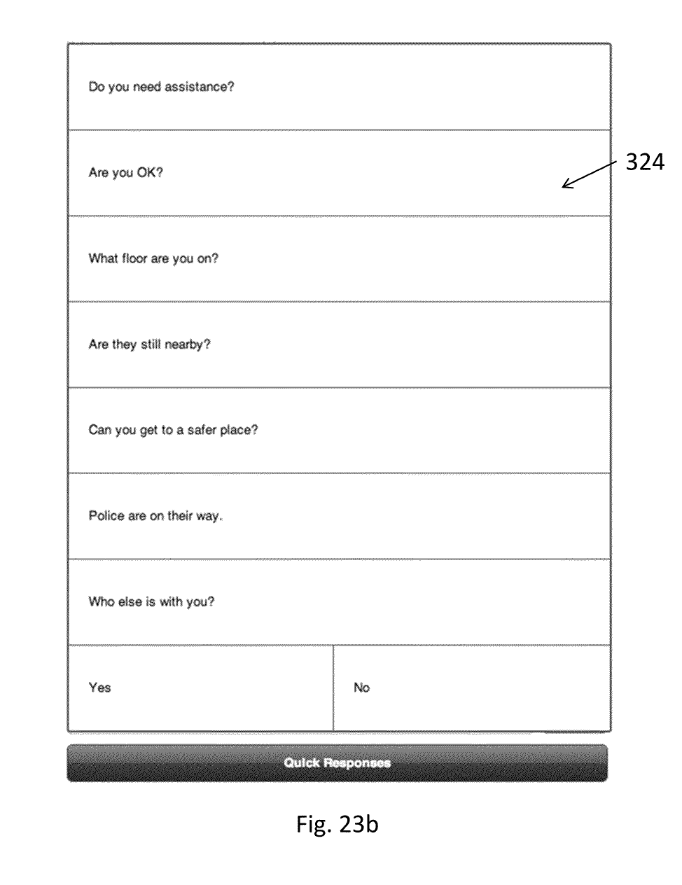

According to an additional feature of quick response mode 330, after the initial text message requesting confirmation of the street address of the user's location has been sent, the graphical user interface 401 of the monitoring application may also present to the monitoring personnel a list of additional possible text messages the monitoring personnel may wish to send to the user. For example, the list may include a number of text messages that may be appropriate in an emergency situation, such as “do you need assistance,” “are you ok?,” “police are on their way,” and “who else is with you.” The monitoring personnel can then simply click on one of the messages to have that message sent to the device. This feature enables the monitoring personnel to quickly communicate with the user, without having to spend the time typing the message in what could be an intense situation. FIG. 22b illustrates how an ongoing text conversation using the quick response feature may appear on the user interface of the mobile application on the user's mobile device. As shown, the initial message 322 appears first (e.g., “Are you still at 37-151 Woodsedge?”), followed by any subsequent messages sent to the mobile device (such as “Do you need assistance” in this example). Alternatively, with reference to FIGS. 23a and 23b, monitoring subsystem 400 may prompt the operator of the monitoring system with a list 324 of suggested text messages to send to user 302. Some or all of the text messages included in list 324 may be based on information received in step 330c.

### Escort Mode

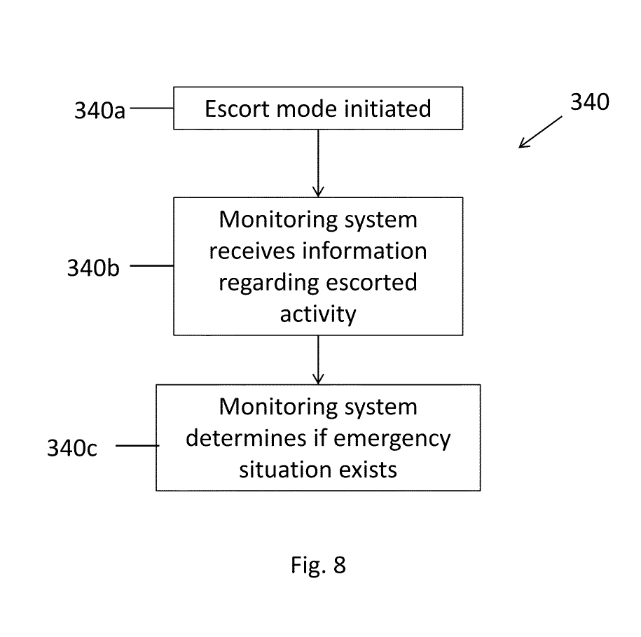

Referring now to FIG. 8, one embodiment of an escort mode is illustrated by the steps of method 340. The escort mode may be used to identify a potential emergency situation while a user 302 is performing a given task. For example, if a user 302 plans to travel from a first location to a second location, escort mode 340 may be initiated to identify a potential emergency situation. Alternatively, if a user 302 plans to take a shower or a nap, escort mode 340 may also be used to identify a potential emergency situation.

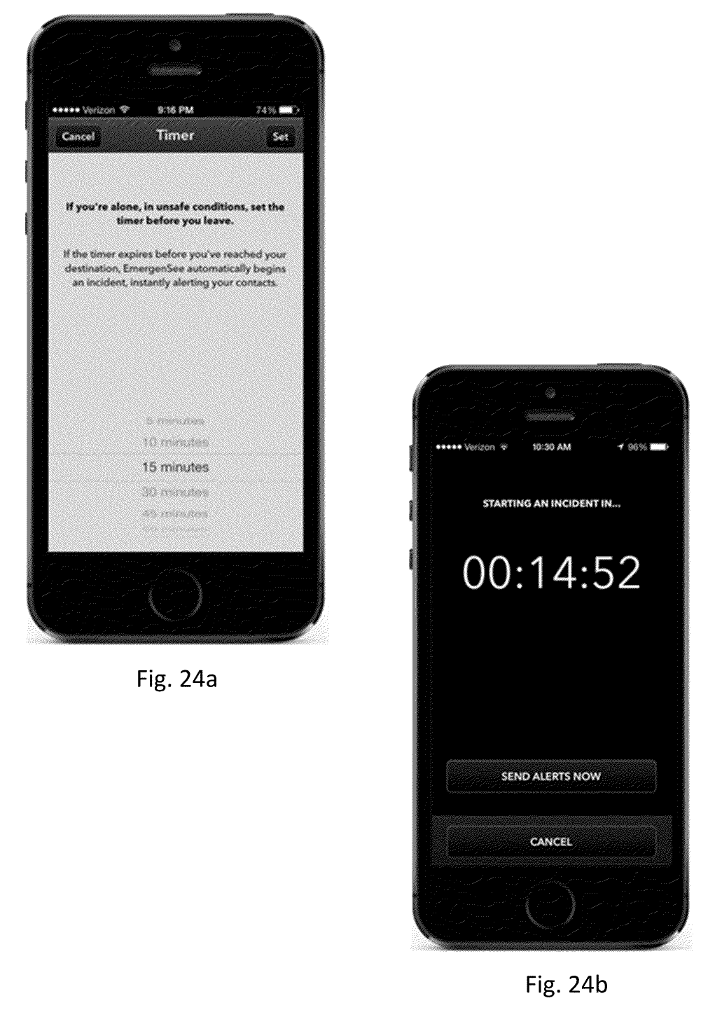

Escort mode 340 may be initiated at step 340a in several ways. For example, a user 302 may initiate escort mode 340 by opening the application 300 on the user's mobile device 110 and turning escort mode 340 on. [For example, user 302 opens application 300 and turns on escort mode 340 by setting a timer as shown in FIG. 24a. As shown in FIG. 24b, the timer counts down on the screen. Device 110 prompts an incident to open if the timer is not cancelled before it runs out. Alternatively, escort mode 340 may be initiated at step 340a remotely from device 110, for example by the monitoring subsystem 400 and/or a local law enforcement agency in response to information received from sources external to device 110. For example, another user 302, such as a parent, may send a request to monitoring subsystem 400 to monitor their child during a walk home from school.

After escort mode 340 is initiated, further information may be received regarding the escorted activity at step 340b. For example, user 302 may identify a monitoring time period. Optionally, user 302 may identify the activity type. The activity type may indicate if the user 302 plans to remain in approximately the same location during the activity, or if the user plans to move to a different location during the length of the activity.

Instead of identifying a monitoring time period, at step 340b, user 302 may identify a location to which the user 302 plans to travel. If user 302 plans to take a walk or go for a run, user 302 may optionally identify an ending location that is the same as the starting location, along with an intended route. Optionally, user 302 may identify a time period associated with the travel, or a mode of travel (i.e., walking, bicycling, or by car).

At step 340c, monitoring subsystem 400 determines if an emergency situation exists. For example, if the information received at step 340b is a monitoring time period, user 302 will be able to disable escort mode 340 before the end of the time period. If, at or near the end of the time period, the escort mode 340 has not been disabled, the device will prompt the user 302 to indicate if an emergency situation exists. If no response is received, or if the user indicates that an emergency situation exists, monitoring subsystem 400 will open an incident and, in one embodiment, automatically enter tracking mode as discussed above. Alternatively, escort mode 340 may be configured such that there is no prompt and monitoring subsystem 400 opens an incident if the time period ends without prior disablement.

In one embodiment, user 302 activates escort mode 340 and indicates a time period, for example, a time period of 15 minutes. Monitoring subsystem 400 receives this information and starts a count-down clock or timer. An additional countdown clock may also be on device 110. If monitoring subsystem 400 fails to receive additional information from the device 110 after the 15 minute period ends, an incident will be opened. By having the countdown clock remote from the device 110, if the device 110 is destroyed, runs out of battery, or turns off, monitoring subsystem 400 will still open an incident.

Optionally, during step 340c, monitoring subsystem 400 may determine if an emergency situation exists based on GPS locations of the device 110 during the time period. For example, if user 302 is planning to take a nap, user 302 may indicate a time period of 60 minutes and that he will remain in approximately the same location. During the 60 minutes, device 110 will send periodic updates to monitoring subsystem 400 of the device's GPS location. If, during the 60 minute time period, monitoring subsystem 400 receives information indicating that the device's GPS location has changed, monitoring subsystem 400 may transmit a prompt to the user 302 to inquire of the user whether an emergency situation exists and/or open an incident.

If instead the information received at step 340b is a location to which the user 302 plans to travel and/or a route that the user 302 plans to use, device 110 will send periodic updates to monitoring subsystem 400 to indicate the GPS locations of the device. Based on the current position of the phone, the ending location, and/or the indicated route, monitoring subsystem 400 will continually determine if the user 302 is on one of a set number of predetermined paths and/or the indicated route. If the user 302 diverges too much from one of the predetermined paths and/or the indicated route, the monitoring subsystem 400 will open an incident. Also, escort mode 340 may be configured such that, if monitoring subsystem 400 does not receive information, such as GPS coordinates, monitoring subsystem 400 will open an incident in response.

Optionally, monitoring subsystem 400 may base step 340c on other information in addition to the predetermined paths. For example, if user 302 provides a mode of transportation or a time period, monitoring subsystem 400 may use this additional information to determine if an emergency situation exists. In one instance, if a user 302 indicates that he plans to travel by car, but the monitoring subsystem 400 receives GPS coordinates indicating a much slower speed of movement, which may be indicative of the car breaking down, the monitoring subsystem 400 will open an incident.

If monitoring subsystem 400 determines that an emergency situation exists, an incident is opened, prompting any of the processes described above.

As the foregoing illustrates, the present invention is directed to systems and methods for monitoring a mobile device user. Changes may be made to the embodiments described above without departing from the broad inventive concepts thereof. Accordingly, the present invention is not limited to the particular embodiments disclosed, but is intended to cover all modifications that are within the spirit and scope of the invention as defined by the appended claims.

What is claimed:

1. A method of monitoring users of a plurality of mobile devices within a predetermined geographical area using a GUI, the method comprising:
receiving a communication from at least one mobile device of the plurality of mobile devices, the communication including GPS coordinates indicating a geographic location of the at least one mobile device;
graphically displaying on the GUI a map of the predetermined geographical area with an icon indicating the geographic location of the at least one mobile device;
receiving visual data from the at least one mobile device;
displaying the visual data from the at least one mobile device on the GUI;
sending text messaging to the at least one mobile device; and
displaying the text messaging on the GUI.

2. The method of claim 1 further comprising determining the at least one agency responsible for emergency situations where the at least one mobile device is located based on the GPS coordinates received in the receiving step.

3. The method of claim 2 further comprising a step of sending an alert to the at least one agency of a reported emergency situation at the geographic location.

4. The method of claim 2 further comprising a step of connecting the at least one agency to a user of the at least one mobile device.

5. A method of facilitating communication with a user of a mobile device comprising:
receiving a communication from the mobile device, the communication indicating that a user of the mobile device is involved in an emergency situation and including GPS coordinates indicating a geographic location of the mobile device;
presenting on a monitor a graphical user interface comprising a list of pre-composed messages based on information received in the communication;
receiving a selection of a pre-composed message from the list of pre-composed messages; and
sending the selected pre-composed message to the mobile device.

6. The method of claim 5, further comprising a step of determining, based on the geographic location indicated by the GPS coordinates, a street address corresponding to the geographic location, and wherein the list of pre-composed messages includes at least one message that includes the street address.

7. A method of facilitating communication with a user of a mobile device comprising:
receiving a communication from the mobile device, the communication indicating that a user of the mobile device is involved in an emergency situation and including GPS coordinates indicating a geographic location of the mobile device;
determining, based on the geographic location indicated by the GPS coordinates, a street address corresponding to the geographic location; and
automatically, and without user intervention, sending a message requesting that the user of the mobile device confirm whether the user is present at the determined street address.

8. The method recited in claim 7, further comprising:
presenting on a monitor a graphical user interface comprising a list of additional pre-composed messages based on information received in the communication;
receiving a selection of a pre-composed message from the list of pre-composed messages; and
sending the selected pre-composed message to the mobile device.

9. The method of claim 7, wherein the sending step comprises sending the message as an SMS text message.

10. A method for monitoring a user of a mobile device during an activity, the method comprising:
receiving a communication from the mobile device, the communication including GPS coordinates indicating a geographic location of the mobile device;
receiving information regarding a predetermined period of time associated with the activity;
setting a timer for the predetermined period of time, the timer disposed remote from the mobile device; and
determining, after the predetermined period of time, whether an emergency situation exists.

11. The method of claim 10 further comprising receiving at least one of audio data from the mobile device and visual data from the mobile device.

12. The method of claim 10 wherein the GPS coordinates are a first set of GPS coordinates and the method further comprises receiving, after the predetermined period of time, a second set of GPS coordinates from the at least one mobile device.

13. A method for graphically displaying information received from a mobile device, the method comprising:
receiving a first communication from the mobile device, the first communication including a first set of GPS coordinates indicating a first geographic location of the mobile device;
graphically displaying on a map a first icon corresponding to the first geographic location;
receiving a second communication from the mobile device, the second communication including a second set of GPS coordinates indicating a second geographic location of the mobile device;
determining a direction of movement of the mobile device from the first and second sets of GPS coordinates; and
graphically displaying on the map a second icon corresponding to the geographic location indicated by the second set of GPS coordinates, the second icon including an arrow indicating the direction of movement.

14. The method of claim 13 further comprising a step of calculating a speed of movement from the first and second set of GPS coordinates.

15. The method of claim 14 wherein the graphically displaying step further includes displaying the speed of movement on the map.

16. The method of claim 13, further comprising:
receiving one or more additional communications from the mobile device, each additional communication including an additional set of GPS coordinates indicating an updated geographic location of the mobile device; and
in response to each received additional communication,
determining a subsequent direction of movement of the mobile device from the additional set of GPS coordinates in the received communication; and
graphically displaying on the map an additional icon corresponding to the updated geographic location indicated by the additional set of GPS coordinates in the received communication, the additional icon including another arrow indicating the subsequent direction of movement determined from the additional set of GPS coordinates.
